(19) United States
(12) Patent Application Publication
(10) Pub. No.: US 2025/0324442 A1
(43) Pub. Date: Oct. 16, 2025

(54) RESOURCE DETERMINING METHOD AND APPARATUS

(71) Applicant: VIVO MOBILE COMMUNICATION CO., LTD., Dongguan (CN)

(72) Inventor: Jiamin LIU, Dongguan (CN)

(21) Appl. No.: 19/252,444

(22) Filed: Jun. 27, 2025

Related U.S. Application Data
(63) Continuation of application No. PCT/CN2023/142110, filed on Dec. 26, 2023.

(30) Foreign Application Priority Data
Dec. 29, 2022 (CN) 202211716069.5

(51) Int. Cl. H04W 72/51; H04W 72/0446

(52) U.S. Cl. CPC H04W 72/51; H04W 72/0446

(57) ABSTRACT

This application discloses a resource determining method and apparatus, and pertains to the field of communication technologies. The resource determining method in embodiments of this application includes: A first communication node determines a transmission resource, where the transmission resource is used to transmit information about an ambient power-enabled internet of things Ambient IoT device.

### CROSS-REFERENCE TO RELATED APPLICATIONS

This application is a bypass continuation application of International Application No. PCT/CN2023/142110, filed on Dec. 26, 2023, which claims the benefit of and priority to Chinese Patent Application No. 202211716069.5, filed on Dec. 29, 2022, both of which are incorporated by reference in their entireties herein.

### TECHNICAL FIELD

This application relates to the field of communication technologies and, more specifically, relates to a resource determining method and apparatus.

### BACKGROUND

To accelerate the deployment of ambient power-enabled Internet of Things (Ambient IoT) devices within a 3rd Generation Partnership Project (3GPP) network, it may be necessary to adapt the architecture and a transmission methods of the 3GPP wireless communication network to support data transmission for such devices.

Accordingly, Ambient IoT device transmissions can be integrated into the wireless communication network.

### BRIEF SUMMARY

Embodiments of this application provide a resource determining method and apparatus.

According to a first aspect, a resource determining method is provided. The method includes:

A first communication node determines a transmission resource, where the transmission resource is used to transmit information about an ambient power-enabled internet of things Ambient IoT device.

According to a second aspect, a resource determining apparatus is provided. The apparatus includes:
a first determining module, configured to determine a transmission resource, where the transmission resource is used to transmit information about an ambient power-enabled internet of things Ambient IoT device.

According to a third aspect, a first communication node is provided. The first communication node includes a processor and a memory, and the memory stores a program or an instruction that is executable on the processor; and when the program or the instruction is executed by the processor, the steps of the method according to the first aspect are implemented.

According to a fourth aspect, a first communication node is provided. The communication node includes a processor and a communication interface. The processor is configured to determine a transmission resource, where the transmission resource is used to transmit information about an ambient power-enabled internet of things Ambient IoT device.

According to a fifth aspect, a resource determining system is provided. The resource determining system includes: a first communication node, where the first communication node may be configured to perform the steps of the resource determining method according to the first aspect.

According to a sixth aspect, a readable storage medium is provided. The readable storage medium stores a program or an instruction; and when the program or the instruction is executed by a processor, the steps of the method according to the first aspect are implemented.

According to a seventh aspect, a chip is provided. The chip includes a processor and a communication interface, the communication interface is coupled to the processor, and the processor is used to run a program or an instruction, to implement the method according to the first aspect.

According to an eighth aspect, a computer program/program product is provided. The computer program/program product is stored in a storage medium, and the computer program/program product is executed by at least one processor to implement the steps of the resource determining method according to the first aspect.

### BRIEF DESCRIPTION OF DRAWINGS

FIG. 1 is a schematic block diagram of a wireless communication system to which embodiments of this application may be applied;

FIG. 2 is a schematic flowchart of receiving and sending data by a Tag device according to a related technology;

FIG. 3 is a schematic diagram of an RFID process and a Tag state according to a related technology;

FIG. 4 is a schematic flowchart of a resource determining method according to an embodiment of this application;

FIG. 5 is a schematic diagram of a system structure of an Ambient IoT including a reader according to an embodiment of this application;

FIG. 6 is a schematic diagram of a structure of a resource determining apparatus according to an embodiment of this application;

FIG. 7 is a schematic diagram of a structure of a communication device according to an embodiment of this application;

FIG. 8 is a schematic diagram of a hardware structure of a terminal according to an embodiment of this application; and

FIG. 9 is a schematic diagram of a network note structure of a terminal according to an embodiment of this application.

### DETAILED DESCRIPTION

The following clearly describes the technical solutions in embodiments of this application with reference to the accompanying drawings in embodiments of this application. Understandably, the described embodiments are some, but not all, embodiments of this application. All other embodiments obtained by a person of ordinary skill in the art based on embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and the character “/” generally represents an “or” relationship between associated objects.

It should be noted that the technologies described in embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” in embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to applications other than the NR system application, for example, a 6^{th} generation (6G) communication system.

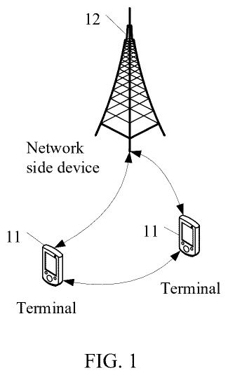

FIG. 1 is a schematic block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a vehicle user equipment (VUE), a pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. Provided that same technical effect is achieved, the base station is not limited to a specified technical term. It should be noted that, in embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application service discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, in embodiments of this application, only a core network device in an NR system is used as an example for description, and a specific type of the core network device is not limited.

First, the following content is described:

(1) Ambient power-enabled internet of things (Ambient IoT) (including Passive IoT).

The Ambient IoT is a 3GPP IoT technology. An Ambient IoT device is with ultra-low complexity and ultra-low power consumption.

The Ambient IoT is an IoT service. The Ambient IoT device supplies energy through energy harvesting, and the Ambient IoT device does not have a battery, or has a limited energy storage capability, for example, uses one capacitor for energy storage. An energy source for energy harvesting includes a radio wave, light, motion, heat, or another suitable energy source.

Energy of the Ambient IoT device is from energy harvesting. For energy storage, the Ambient IoT device may have the following features:
(a) having no battery and no energy storage, and completely relying on an external energy source; or
(b) having a limited energy storage capability, without battery replacement or charging.

Optionally, the Ambient IoT device does not have a conventional battery. The Ambient IoT device may use energy harvested from a radio wave, and the radio wave may be from a network device or a user equipment, for example, a mobile phone UE.

Optionally, the Ambient IoT device may be classified based on an energy source, an energy storage capability, passive or active transmission, or the like.

Optionally, refer to a related technology. Passive or active transmission of the Ambient IoT device includes the following plurality of communication modes:
(a) normal operation, where the Ambient IoT device with electrical energy can continuously work or continuously work for a period of time; and the energy may be from continuous energy harvesting, or may have a specific energy storage capability, for example, the Ambient IoT device is equipped with a capacitor;
(b) active transmission, supporting the operation triggered by the Ambient IoT device, where the Ambient IoT device can support only a short-time active state, and supports intermittent communication; the Ambient IoT device can decide when to communicate with the network; and the Ambient IoT device does not necessarily monitor the network, that is, may not monitor a called service for long time; and
(c) passive transmission, supporting only an on-demand operation initiated by the network side, where the Ambient IoT device cannot initiate a service by itself.
(2) Information transmission between a reader and a backscatter (BSC) device (for example, an electronic tag device, also referred to as a Tag device) in a radio frequency identification (RFID).

The RFID is a conventional backscatter communication system, and may identify an ID and read data of the BSC device (namely, the Tag device) in a coverage area of the reader. A process of performing identification and data reading on the Tag device is also referred to as inventory taking because the RFID is initially applied to automated inventory of a large quantity of goods.

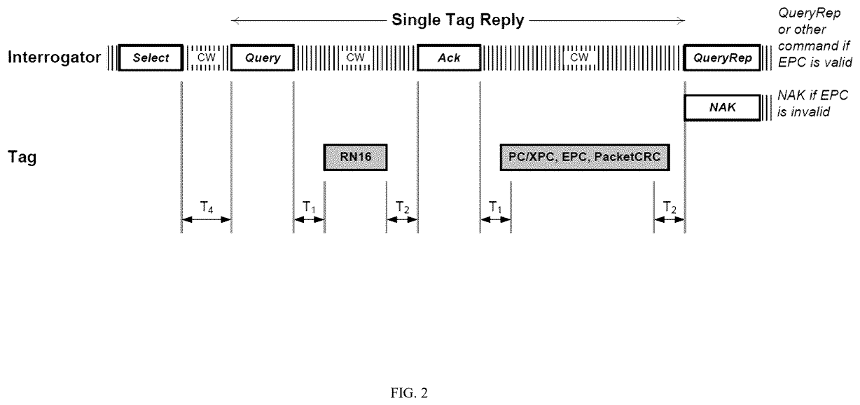

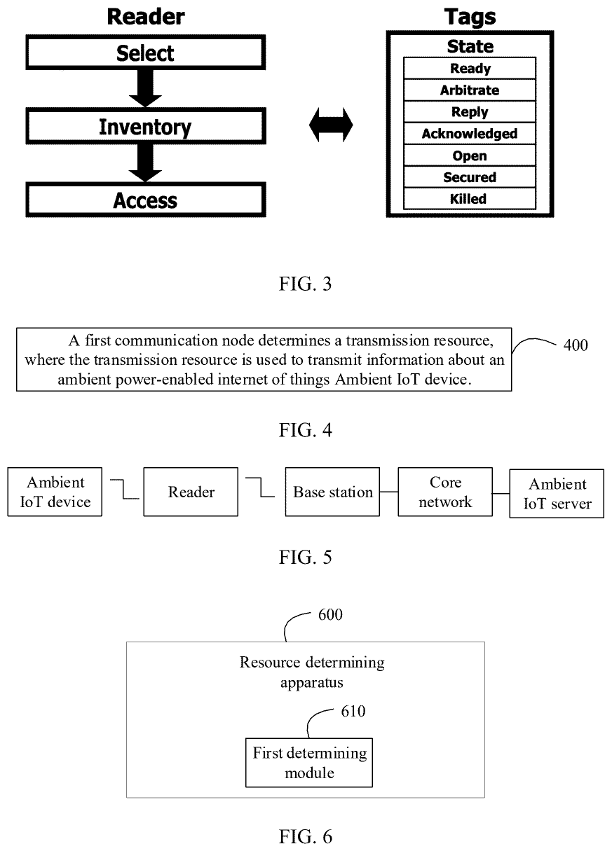

An EPC C1G2 RFID system defined by using a related technology is used as an example. FIG. 2 is a schematic flowchart of receiving and sending data by a Tag device according to a related technology. FIG. 3 is a schematic diagram of an RFID process and a Tag state according to a related technology. As shown in FIG. 2 and FIG. 3, after a reader send a query instruction (Query), the Tag device responds to a reply (Reply). The reply being RN16 is used as an example. A 16-bit random number is generated by the Tag device and sent to the reader. Then, the reader sends the sequence to the Tag device by using an acknowledgment (ACK) instruction. After successfully verifying RN16 in the ACK, the Tag device sends subsequent data (for example, a PC/XPC or an EPC) to the reader.

For an example of an operation instruction of the reader, refer to the following Table 1:

TABLE 1

| Operation type | Instruction | Function |
|---|---|---|
| Select | Select | Select a tag |
| Inventory | Query | Start an inventory action |
| | | Generate a random number to determine response |
| | | time |
| | Query Adjust | Adjust a quantity of original slots of the tag |
| | QueryRep | Tags are reduced by a quantity of slots of the tags |
| | EPC | The reader responds to an instruction for the tag |
| | acknowledgment | |
| | (ACK) | |
| | NAK | Instruction sent by the reader |
| | | The tag returns to an arbitrate state |
| Access | Random request | The tag is required to generate a random number |
| | (Req_RN) | |
| | Read | Read data from a specific location in the stored tag |
| | Write | Write the data into the stored tag |
| | Kill | No more response to any reader |
| | | Prevent privacy leakage |
| | | The tag cannot be used again |
| | Lock | No more writing action can be performed on the |
| | | tag |
| | | Prevent the data from being tampered with at |
| | | random |
| | Access (optional) | When the tag has a password, change the tag from |
| | | an open state to a secure state |
| | BlockWrite | Write a plurality of blocks at a time |
| | (optional) | |
| | Lock Erase | The plurality of blocks are cleared from stored a |
| | (optional) | single tag |

For an example of a tag state of the Tag device, refer to Table 2:

TABLE 2

| Tag state | Descriptions |
|---|---|
| Ready | Not in a current inventory operation |
| Arbitrate | The tag is currently in a specific inventory operation |
| | Indicating that a number of a slot is not 0 and is still waiting |
| Reply | Generate a 16-bit random number to the reader |
| | A state in which acknowledgment is performed when one ACK |
| | message is received |
| | Return to an arbitrate state when no ACK message is received |
| Acknowledge | Enter any state other than a killed state from this state |
| Open | When an instruction of a random request is received when a tag |
| | whose password is not zero is in an acknowledgment state |
| Secure | A tag whose password is zero is received when an instruction of a |
| | random request sent by the reader is received in the |
| | acknowledgment state |
| Killed | Permanently unavailable |

### (3) Backscatter Communication (BSC)

Backscatter communication means that a backscatter communication device performs signal modulation by using a radio frequency signal in another device or an environment to transmit information of the backscatter communication device. The backscatter communication terminal device (a BSC Tag, also referred to as a BSC UE) may be a Tag in a conventional RFID, an Ambient IoT, or a Passive-IoT device.

The backscatter technology is a passive or low-power-consumption technology. A technical feature of the backscatter technology is that transmission of a signal of the backscatter technology can be completed by changing a characteristic, for example, phase or amplitude information, of a received ambient radio frequency signal, to implement transmission of extremely low-power-consumption or zero-power-consumption information.

In terms of an energy supply manner, the backscatter communication terminal device (the BSC Tag) may be divided into three manners: passive, semi-passive, and active.
(a) For passive backscatter communication, the BSC TAG first obtains energy (Energy harvesting) from an external electromagnetic wave, supplies a circuit module such as internal channel coding and modulation to work, and communicates with a backscatter radio frequency signal, to implement zero-power-consumption communication.
(b) For a semi-passive BSC TAG, an internal circuit module of the semi-passive BSC TAG is powered by a battery of the semi-passive BSC TAG, and communicates with the backscatter radio frequency signal. The internal battery is only used for simple work of the internal circuit module such as channel coding and modulation, and power consumption is very low. Therefore, a battery life of the BSC TAG can reach more than 10 years. All external radio frequency signals can be used for backscatter communication without storing some energy for power supply.
(c) For an active BSC TAG, a built-in battery of the active BSC TAG is not only used for simple work of an internal circuit such as channel coding and modulation, but also for work of a circuit such as power amplification (PA) and low noise amplification (LNA). Therefore, signal modulation and demodulation of more complex backscatter communication can be implemented.

The related technology does not relate to a resource allocation method for communication between an Ambient IoT device and a reader in a 3GPP wireless communications network. The resource allocation method of the related technology cannot be directly applied to the IoT device. Because of a specific requirement of the IoT device, a new design needs to be considered, to be applicable to a scenario in which the IoT device coexists with a legacy UE, and interference and impact on the legacy UE is minimized as much as possible.

With reference to the accompanying drawings, the following describes in detail a resource determining method and apparatus provided in embodiments of this application by using some embodiments and application scenarios thereof.

FIG. 4 is a schematic flowchart of a resource determining method according to an embodiment of this application. As shown in FIG. 4, the method includes the following steps.

Step 400: A first communication node determines a transmission resource, where the transmission resource is used to transmit information about an ambient power-enabled internet of things Ambient IoT device.

Optionally, the first communication node may be a node in a communication system.

Optionally, the first communication node may be a terminal.

Optionally, the first communication node may be a network node.

Optionally, when the first communication node is the network node, the first communication node may be a base station (generation NodeB, gNB), or may be another network node having an air interface capability, for example, may be an integrated access and backhaul (IAB) node, or a DU node in a centralized unit (CU)-distributed unit (DU) architecture.

Optionally, when the first communication node is the network node, the first communication node may be any network node having a Uu air interface capability. This is not limited in this embodiment of this application.

In embodiments of this application, the first communication node is a gNB or a UE. Content applicable to the gNB or the UE in embodiments is also applicable to another possible first communication node. Details are not described in embodiments of this application.

Optionally, the first communication node may determine the transmission resource used to transmit the information about the Ambient IoT device. For example, in a case that the first communication node is the network node, the network node may autonomously configure an appropriate resource for transmitting the information about the ambient power-enabled internet of things Ambient IoT device. For example, in a case that the first communication node is the terminal, the terminal may determine, based on a resource configuration on a network side, the transmission resource used to transmit the information about the Ambient IoT device.

Optionally, the first communication node may determine the transmission resource used to transmit the information about the Ambient IoT device, to implement a transmission requirement of the Ambient IoT device, and the transmission resource does not greatly affect and interfere with other communication in a wireless communication network.

Optionally, the first communication node may exist as an identity of a reader in a system structure of an Ambient IoT.

In an embodiment, FIG. 5 is a schematic diagram of a system structure of an Ambient IoT including a reader according to an embodiment of this application. As shown in FIG. 5, the related reader may be the first communication node, for example, a handheld terminal, or may be a fixedly deployed or mobile deployed read/write device unit. The related Ambient IoT device may be a passive communication-based terminal device, or may be an active communication-based terminal device.

Optionally, communication between the reader and the Ambient IoT device may be based on a backscatter communication mechanism, or may be based on an active communication manner in which the Ambient IoT device autonomously generates a transmit radio wave.

In this embodiment of this application, the transmission resource used to transmit the information about the Ambient IoT device is determined, to implement a transmission requirement of the Ambient IoT device, so that impact and interference caused on the other communication in the wireless communication network can be avoided, and excessive complexity is not introduced to the network, thereby implementing coexistence between the Ambient IoT device and the other communication, and improving communication quality.

Optionally, the transmission resource includes a downlink transmission resource, and the first communication node includes a network node; and
that a first communication node determines a transmission resource includes at least one of the following:
the first communication node determines that the downlink transmission resource includes a downlink slot in which downlink transmission of a terminal is located;
the first communication node determines that the downlink transmission resource and the downlink transmission of the terminal are in different downlink slots; and
the first communication node determines that the downlink transmission resource includes a first downlink slot, where the first downlink slot is not used for the downlink transmission of the terminal.

Optionally, because the network node is a resource scheduling and control node, the network node has a resource allocation and coordination function. When allocating a resource, a legacy network node only needs to consider a communication requirement of a legacy UE, while a network node that supports an Ambient IoT function needs to ensure communication of the legacy UE and also needs to ensure communication of an IoT device.

Optionally, in a case that the first communication node is the network node, when the network node needs to send a signal to the Ambient IoT device for subsequent feedback and response, a downlink signal and a feedback resource allocation problem need to be considered.

Optionally, in a case that the first communication node is the network node, the downlink signal sent by the first communication node to the Ambient IoT device may be sent in a common downlink slot in which the Ambient IoT device communicates with the legacy UE, and manners such as time division, frequency division, code division, and space division multiplexing are used between different UEs and different IoT requirements.

For example, for a specific downlink slot, transmission of information of at least one legacy UE and one Ambient IoT device may be multiplexed in the downlink slot.

Optionally, in a case that the first communication node is the network node, the downlink signal sent by the first communication node to the Ambient IoT device may alternatively be sent in a downlink slot independent of that used by the legacy UE.

Optionally, in a case that the first communication node is the network node, a specific resource dedicated to transmission of the information about the Ambient IoT device may be set.

For example, a first downlink slot dedicated to the transmission of the information about the Ambient IoT device may be set.

In this embodiment of this application, when configuring the transmission resource of the information about the Ambient IoT device, the network node considers the downlink signal and the feedback resource allocation problem, that is, communication of the legacy UE can be ensured, and communication of the IoT device can also be ensured, thereby improving communication quality.

Optionally, that a first communication node determines a transmission resource includes:

The first communication node determines that the information about the Ambient IoT device is carried on a physical downlink channel, where the physical downlink channel carries an IoT dedicated parameter, or a parameter field of the physical downlink channel includes an IoT dedicated parameter field, or the physical downlink channel is not used for the downlink transmission of the terminal.

Optionally, in a case that the first communication node is the network node, the downlink signal sent by the first communication node to the Ambient IoT device may be sent in a format common to a legacy receiving UE, for example, a PDCCH and a PDSCH.

Optionally, in a case that the first communication node is the network node, the downlink signal sent by the first communication node to the Ambient IoT device may be sent in a format common to a legacy receiving UE, for example, a PDCCH and a PDSCH. The PDCCH may carry a special parameter (the IoT dedicated parameter) dedicated to the IoT requirement.

Optionally, in a case that the first communication node is the network node, the downlink signal sent by the first communication node to the Ambient IoT device may be sent in a format common to a legacy receiving UE, for example, a PDCCH and/or a PDSCH. An existing parameter field (the IoT dedicated parameter field) may be re-interpreted or defined, and a special identifier is used to identify the IoT dedicated parameter field.

For example, a manner such as a special C-RNTI for scrambling or a special field value is used as the special identifier to identify the IoT dedicated parameter field.

Optionally, the special identifier is used to identify the IoT dedicated parameter field or carry the IoT dedicated parameter, and may be used for distinguishing from a common UE.

Optionally, in a case that the first communication node is the network node, the downlink signal sent by the first communication node to the Ambient IoT device may be sent in a format common to a legacy receiving UE, for example, a PDCCH and/or a PDSCH. The PDSCH may carry IoT control signaling and fill in information based on a corresponding format.

Optionally, in a case that the first communication node is the network node, the downlink signal sent by the first communication node to the Ambient IoT device may be sent in an independent format.

For example, a format similar to a PDCCH and a PDSCH may be redesigned based on the IoT requirement, to carry the information about the Ambient IoT device.

Optionally, the PDCCH and PDSCH formats commonly used by the UE are not used for downlink transmission of the Ambient IoT device, but a dedicated format is used to carry the information about the Ambient IoT device.

In this embodiment of this application, a means such as a special format or a special identifier is used for distinguishing from the common UE, to clearly distinguish between the common UE communicating with the network node and the carrying Ambient IoT device, so that the downlink signal and the feedback resource allocation problem can be better resolved, that is, communication of the legacy UE can be ensured, and communication of the IoT device can also be ensured, thereby improving communication quality.

Optionally, the transmission resource further includes a resource reservation window, and the resource reservation window is used for an uplink response of the Ambient IoT device; and
that a first communication node determines a transmission resource includes at least one of the following:
the first communication node determines a start location of the resource reservation window based on a location of the downlink transmission resource and a minimum interval between the downlink transmission resource and the uplink response; and
the first communication node determines a length of the resource reservation window based on transmission-related information, where the transmission-related information includes at least one of the following: strength of a signal sent by a base station, a coverage area of the base station, information about a transmission link of the information about the Ambient IoT device, occlusion information of the transmission link, a quantity of Ambient IoT devices in the coverage area of the base station, and density of Ambient IoT devices in the coverage area of the base station.

Optionally, in a case that the first communication node is the network node, when determining a resource location of the downlink signal, the first communication node also needs to consider a location of a feedback and a response of the Ambient IoT device.

For example, because a large quantity of Ambient IoT devices are all passive devices or minimalist devices with extremely limited energy sources, the Ambient IoT device may have only a scattering function of the downlink signal with a high possibility, and cannot actively transmit the uplink response and a feedback signal, in other words, cannot freely select a location of the feedback signal and a location of the response signal. That is, there may be a fixed time sequence relationship between the downlink signal and an uplink feedback/response signal. Therefore, when the downlink signal is allocated, it is also necessary to consider reserving a corresponding resource location for the uplink feedback/response signal.

Optionally, when it is considered to reserve the corresponding resource location for the uplink feedback/response signal, a resource reservation window may be reserved enough to ensure that the uplink feedback/response signal of the Ambient IoT device can be transmitted to the first communication node based on comprehensive consideration of a location, a path status, and/or the like of the Ambient IoT device.

Optionally, in a case that there is a large quantity of Ambient IoT devices, to avoid collision, a specific time window (the resource reservation window) may be required for resource reservation of the uplink feedback/response signal.

Optionally, the start location of the resource reservation window may be determined by a minimum interval between the downlink signal and the uplink response, and may be generally considered as a predetermined value or may be estimated based on a specific device capability.

Optionally, the length of the resource reservation window may be determined based on factors such as the strength of the signal sent by the base station, the coverage area, the link and occlusion, the quantity and the density of IoT devices, and the like, and may be determined by the network side through calculation based on a related technology.

In this embodiment of this application, the resource is reserved for feedback of the Ambient IoT device, so that integrity of an Ambient IoT service procedure can be ensured.

Optionally, the resource reservation window is located in a location of an uplink transmission resource of the terminal, and/or the resource reservation window is located in a location of a random access resource of the terminal.

Optionally, in a case that the first communication node is the network node, a location at which the downlink signal sent by the first communication node to the Ambient IoT device may be consistent with a downlink resource location of the common UE.

For example, in a TDD system, the location at which the downlink signal sent by the first communication node to the Ambient IoT device may be located in a same downlink slot as the downlink resource location of the common UE, so that mutual interference can be reduced.

For example, in an FDD system, the location at which the downlink signal sent by the first communication node to the Ambient IoT device may be located in a same downlink frequency band as or a different downlink frequency band from the downlink resource location of the common UE, so that mutual interference can be reduced.

Optionally, in a case that the first communication node is the network node, the downlink signal sent by the first communication node to the Ambient IoT device triggers the Ambient IoT device to perform uplink feedback and response. A location of a resource for the uplink feedback and response may be consistent with an uplink resource location of the common UE.

Optionally, to reduce interference, an uplink signal of the common UE is sent in a manner of uplink synchronization to the base station, and some UE signals without uplink synchronization are integrated at some dedicated locations for sending. For example, a RACH resource location is used when the UE that does not establish uplink synchronization with the base station sends an initial access signal.

Optionally, transmission of the information about the Ambient IoT device may also be considered as that there is no uplink synchronization. Therefore, the Ambient IoT device may send an uplink signal together with the unsynchronized common UE, for example, integrate the uplink signal at a RACH resource location for sending, so that interference to data of another normally synchronized UE can be reduced.

Optionally, the common UE may be a UE that is in a coverage area or a communication range of the network node and that is executing another communication service.

In this embodiment of this application, the resource reservation window is located in the location of the uplink transmission resource of the terminal, and/or the resource reservation window is located in the location of the random access resource of the terminal, so that the downlink signal and the feedback resource allocation problem are properly resolved, that is, communication of the legacy UE can be ensured, and communication of the IoT device can also be ensured, thereby avoiding mutual interference, and improving communication quality.

Optionally, the method further includes:

The first communication node sends first indication information to the Ambient IoT device, where the first indication information is used to indicate at least one of the following: the start location of the resource reservation window and the length of the resource reservation window.

Optionally, after determining the resource reservation window, the first communication node may indicate the resource reservation window to the Ambient IoT device by using the first indication information.

Optionally, the base station may include the first indication information in the downlink signal, or may include the first indication information in PDCCH control signaling, or may include the first indication information in IoT signaling format content in a PDSCH.

Optionally, after receiving the first indication information, the Ambient IoT device performs a transmission operation based on the resource reservation window indicated by the first indication information.

Optionally, the transmission resource includes a reserved uplink transmission resource, and the uplink transmission resource is used for active reporting of the Ambient IoT device; and
in a case that the first communication node includes the network node, that a first communication node determines a transmission resource includes:
the first communication node determines first information separately corresponding to at least one group of period resource groups, where the first information includes at least one of the following: a period interval, a resource size, an applicable transmission requirement, an applicable transmission service, and a use rule.

Optionally, when there is a requirement for actively sending a signal by the Ambient IoT device in the network, the network side (for example, the network node used as the first communication node) also needs to perform uplink resource allocation on the Ambient IoT device, to meet a resource sending requirement of the Ambient IoT device.

Optionally, to minimize back-and-forth interaction and power consumption as much as possible, the network side (for example, the network node used as the first communication node) may perform resource pre-allocation for uplink transmission of the active Ambient IoT device in a periodic reservation and allocation manner, that is, reserve the uplink transmission resource.

For example, the network side may reserve a resource of a specific size or the like at a specific period interval for use in the uplink transmission of the active Ambient IoT device.

Optionally, the network side may reserve one or more sets of resources, and has different periods and different resource sizes, to meet different transmission requirements; or may formulate a rule for use of the resource, for example, send information such as a specific type of resource, resource allocation, and a rule that are used by a service that meets specific requirements to the Ambient IoT device by using some interaction processes, for example, send and possibly update by using a DL-triggered signaling process. After obtaining a configuration, the Ambient IoT device may use the configuration as required.

Optionally, the transmission resource includes an uplink transmission resource, and
before that a first communication node determines a transmission resource, the method further includes:
the first communication node receives, at a reserved first indication resource location, second information of the Ambient IoT device, where the second information is used to represent that the Ambient IoT device needs to send an uplink signal; and
that a first communication node determines a transmission resource includes:
the first communication node determines the uplink transmission resource.

Optionally, when there is a requirement for actively sending a signal by the Ambient IoT device in the network, the network side (for example, the network node used as the first communication node) also needs to perform uplink resource allocation on the Ambient IoT device, to meet a resource sending requirement of the Ambient IoT device. The first communication node may receive the second information of the Ambient IoT device at the reserved first indication resource location, determine, based on the second information, that there is the requirement for actively sending the signal by the Ambient IoT device, and then configure the uplink transmission resource for the active Ambient IoT device after receiving the second information.

Optionally, a specific uplink indication resource location (the first indication resource location) may be reserved. When the Ambient IoT device has an active transmission requirement, the Ambient IoT device may perform indication (that is, send the second information) at the first indication resource location. After receiving the second information, the first communication node (for example, the network node) performs resource allocation, and configures the uplink transmission resource for the active Ambient IoT device.

Optionally, the second information includes at least one of the following:
second indication information, where the second indication information is used to indicate that the Ambient IoT device needs to send the uplink signal;
a resource size required for the uplink signal that needs to be sent by the Ambient IoT device; and
a service type corresponding to the uplink signal.

Optionally, a first indication resource may include only 1 bit, and the 1 bit is used to indicate that there is a UL requirement.

Optionally, the first indication resource may carry related information of active transmission of the active Ambient IoT device, for example, information such as the required resource size and/or the service type, so that the network determines attributes such as a delay and a size of the allocated resource.

In an embodiment, when there is a requirement for actively sending a signal by the Ambient IoT device in the network, the network side also needs to perform uplink resource allocation on the device, to meet a resource sending requirement of the device. To minimize back-and-forth interaction and power consumption as much as possible, the network may perform uplink resource allocation on the active Ambient IoT device in a periodic reservation and allocation manner, for example, may reserve a resource of a specific size at a specific period interval for use. In addition, the network may reserve more than one set of resources or a plurality of sets of resources, and has different periods and different resource sizes, to meet different transmission requirements; or may formulate a rule for use of the resource, for example, send information such as a specific type of resource, resource allocation, and a rule that are used by a service that meets specific requirements to the Ambient IoT device by using some interaction processes, for example, send and possibly update by using a DL-triggered signaling process. After obtaining a configuration, the Ambient IoT device may use the configuration as required. Alternatively, the network may reserve only a specific first indication resource location. When the Ambient IoT device has a requirement, the Ambient IoT device performs indication (the second information) at the first indication resource location. After receiving the second information, the network performs resource allocation. The first indication resource location may include only the 1 bit, and the 1 bit indicates that there is a UL requirement. Or the first indication resource may additionally carry the information such as the required approximate resource size and/or the service type, so that the network determines the attributes such as the delay and the size of the allocated resource.

Optionally, the first communication node includes a terminal, and
that a first communication node determines a transmission resource includes at least one of the following:
the first communication node requests the transmission resource from a network side; and
the first communication node receives a resource grant sent by the network side, where the resource grant is used to indicate related information of the transmission resource.

Optionally, because the network node is generally far away from the IoT device and requires high transmit power and a large coverage area, a nearby UE may directly communicate with the Ambient IoT device as the first communication node, and then forward response information of the Ambient IoT device to the network side, which is also a reasonable and feasible manner of the Ambient IoT device, so that an Ambient IoT communication delay can be reduced.

Optionally, because a resource used for UE communication in the network is generally also scheduled and managed by a base station, especially when the UE is in an RRC CONNECTED state, the resource used by the UE to communicate with the Ambient IoT device as the first communication node may alternatively be configured by the network side.

In a case that the first communication node is the terminal (the UE), when determining to communicate with the Ambient IoT device, the UE reports a requirement to the network side, and requests the transmission resource from the network side, to obtain resource allocation of the network side.

Optionally, that the UE determines to communicate with the Ambient IoT device includes at least one of the following:
(1) the first communication node receives control information sent by a third communication node, where the control information is used to indicate the first communication node to communicate with the Ambient IoT device, where
for example, when the UE receives information of another control node, and needs to perform active signal sending on the IoT device and expects a subsequent response and feedback, the UE may report the requirement to the network side, to obtain the resource allocation of the network side;
(2) the first communication node determines that a first trigger condition is met, where the first trigger condition is used to trigger the first communication node to communicate with the Ambient IoT device, where
for example, when the locally stored first trigger condition is met, and the UE needs to perform active signal sending on the IoT device and expects a subsequent response and feedback, the UE may report the requirement to the network side, to obtain the resource allocation of the network side;
(3) when the UE has a requirement of periodically communicating with the IoT device, for example, periodic inventory or measurement result collection, the UE may alternatively report this periodic requirement to the network side; and
(4) the first communication node determines that the Ambient IoT device needs to send a signal to the first communication node;
the first communication node receives, at a reserved second indication resource location, third information of the Ambient IoT device, where the third information is used to represent that the Ambient IoT device needs to send an uplink signal; and
the first communication node determines that the Ambient IoT device needs to periodically send the signal to the first communication node.

For example, when there is a requirement for periodic active communication of the IoT device near the UE, or a single-trigger-based requirement, the IoT device notifies the UE of the requirement by using some preconfigured locations, the UE reports the requirement to the base station; the base station allocates a resource based on the requirement, where the allocated resource may be directly sent by the base station to the IoT device, or may be forwarded by the UE; and then the IoT device uses based on the allocated resource.

Optionally, before that the first communication node requests the transmission resource from a network side, the method further includes at least one of the following:
the first communication node receives control information sent by a third communication node, where the control information is used to indicate the first communication node to communicate with the Ambient IoT device; and
the first communication node determines that a first trigger condition is met, where the first trigger condition is used to trigger the first communication node to communicate with the Ambient IoT device.

Optionally, in a case that the first communication node is the terminal (the UE), the first communication node may determine, based on control information of another control node (the third communication node), to communicate with the Ambient IoT device.

Optionally, in a case that the first communication node is the terminal (the UE), the first communication node may determine to communicate with the Ambient IoT device when a first trigger condition that is preset, locally stored, or indicated by another communication node is met.

Optionally, in a case that the first communication node is the terminal (the UE), when the UE receives control information of another control node (the third communication node), or because a locally-stored trigger condition is met, the UE needs to perform active signal sending on the Ambient IoT device and expects a subsequent response and feedback, the UE may report the requirement to the network side, and request the transmission resource from the network side, to obtain the resource allocation of the network side.

In an embodiment, when the UE receives the information of another control node, or because the locally-stored trigger condition is met, the UE needs to perform active signal sending on the Ambient IoT device and expects the subsequent response and feedback, the UE may report the requirement to the network side, to obtain the resource allocation of the network side. The reporting requirement may be multiplexed with an existing process, for example, a BSR process or an SR process, or may be performed by using a separate reporting process. The information that needs to be carried includes at least one of the following: a requirement for communication between the UE and the Ambient IoT device, a resource size required for communication between the first communication node (for example, the terminal) and the Ambient IoT device, a communication type of the Ambient IoT device, transmit power information of the UE, coverage information, location information, a quantity and/or density of Ambient IoT devices near the UE, a resource or resource reservation window that needs to be reserved for uplink transmission, link quality of the first communication node, surrounding interference, and the like.

After receiving reporting of a single resource request, the base station sends a resource grant to the UE based on the requirement of the UE, where the resource grant includes not only a resource for sending a signal to the IoT device by the UE, but also a window resource for responding by the IoT device. The network side may send the two parts of resources to the UE, or send only the first part of resources used by the UE to the UE. The second part is reserved by a system or is synchronization-associated with the first part by default, and is not allocated to other nearby transmission for use, to ensure effect of this time of IoT communication, and reduce mutual interference.

Optionally, that the first communication node requests the transmission resource from a network side includes:

The first communication node sends transmission resource request information to the network side, where the transmission resource request information includes at least one of the following:
a requirement for communication between the first communication node and the Ambient IoT device;
a resource size required for the communication between the first communication node and the Ambient IoT device;
a type for the communication between the first communication node and the Ambient IoT device;
transmit power information of the first communication node;
coverage information of the first communication node;
location information of the first communication node;
a quantity of Ambient IoT devices near the first communication node;
density of Ambient IoT devices near the first communication node;
related information of a response window, where the response window is used to transmit a response of the Ambient IoT device to the first communication node;
a third indication information, where the third indication information is used to indicate the first communication node to request a periodic transmission resource; and
period information of the periodic transmission resource requested by the first communication node.

Optionally, the first communication node (for example, the terminal) reports the requirement to the network side, and a process of requesting the transmission resource from the network side may be multiplexed with a reporting procedure in a related technology, for example, a BSR or an SR process.

Optionally, the first communication node (for example, the terminal) reports the requirement to the network side, and a process of requesting the transmission resource from the network side may be performed by using a separate reporting process.

Optionally, when the first communication node (for example, the terminal) reports the requirement to the network side, and requests the transmission resource from the network side, the first communication node may send the transmission resource request information to the network side. The information that needs to be carried includes at least one of the following: a requirement for communication between the UE and the Ambient IoT device, a resource size required for communication between the first communication node (for example, the terminal) and the Ambient IoT device, a communication type of the Ambient IoT device, transmit power information of the UE, coverage information, location information, a quantity and/or density of Ambient IoT devices near the UE, a resource or resource reservation window that needs to be reserved for uplink transmission, link quality of the first communication node, surrounding interference, and the like.

Optionally, the requirement for the communication between the terminal and the Ambient IoT device may be a single communication requirement or a periodic communication requirement.

Optionally, if the requirement of the communication between the terminal and the Ambient IoT device may be the periodic communication requirement, the transmission resource request information may further include the third indication information and/or the period information of the periodic transmission resource requested by the first communication node.

Optionally, the related information of the transmission resource includes at least one of the following:
related information of a resource used by the first communication node to send a signal to the Ambient IoT device;
the related information of the response window used by the Ambient IoT device to respond to the first communication node;
period information of the resource used by the first communication node to send the signal to the Ambient IoT device; and
period information of the response window.

Optionally, after the first communication node requests the transmission resource from the network side, the first communication node receives the resource grant sent by the network side, where the resource grant indicates the related information of the transmission resource, and may specifically indicate at least one of the following:
the related information of the resource used by the first communication node to send the signal to the Ambient IoT device;
the related information of the response window used by the Ambient IoT device to respond to the first communication node;
the period information of the resource used by the first communication node to send the signal to the Ambient IoT device; and
the period information of the response window.

Optionally, in a case that the requirement of the communication between the terminal and the Ambient IoT device is the single communication requirement, the resource grant indicates the related information of the transmission resource, and the related information may include the related information of the resource used by the first communication node to send the signal to the Ambient IoT device, and/or the related information of the response window used by the Ambient IoT device to respond to the first communication node.

Optionally, in a case that the requirement of the communication between the terminal and the Ambient IoT device is the periodic communication requirement, the resource grant indicates the related information of the transmission resource, and the related information may include the related information of the resource used by the first communication node to send the signal to the Ambient IoT device, and/or the related information of the response window used by the Ambient IoT device to respond to the first communication node; or may include the period information of the resource used by the first communication node to send the signal to the Ambient IoT device, and/or the period information of the response window.

Optionally, the related information of the response window used by the Ambient IoT device to respond to the first communication node may alternatively be determined based on system reservation, or is synchronization-associated, by default, with the resource of the signal sent by the first communication node to the Ambient IoT device. For example, a fixed-length resource after the resource used by the first communication node to send the signal to the Ambient IoT device is reserved by default as the response window. In this case, the network side may not need to indicate the related information of the response window to the terminal.

In an embodiment, after receiving reporting of a single resource request, the network side, for example a base station, sends a resource grant to the UE based on the requirement of the UE, where the resource grant includes not only a resource for sending a signal to the Ambient IoT device by the UE, but also a window resource for responding by the Ambient IoT device. The network side may send the two parts of resources to the UE, or send only the first part of resources used by the UE to the UE. The second part is reserved by a system or is synchronization-associated with the first part by default, and is not allocated to other nearby transmission for use, to ensure effect of this time of IoT communication, and reduce mutual interference.

Optionally, before that the first communication node requests the transmission resource from a network side, the method further includes at least one of the following:
the first communication node determines that the Ambient IoT device needs to send a signal to the first communication node;
the first communication node receives, at a reserved second indication resource location, third information of the Ambient IoT device, where the third information is used to represent that the Ambient IoT device needs to send an uplink signal; and
the first communication node determines that the Ambient IoT device needs to periodically send the signal to the first communication node.

Optionally, a specific uplink indication resource location (the second indication resource) may be reserved. When the Ambient IoT device has an active transmission requirement, the Ambient IoT device may perform indication (that is, send the third information) at the second indication resource location. After receiving the third information, the first communication node (for example, the terminal) reports the requirement to the network side, and requests the transmission resource from the network side, to obtain resource allocation of the network side.

Optionally, when there is a periodic active communication requirement of the Ambient IoT device near the first communication node (for example, the terminal), for example, reporting of a periodic measurement result, the UE may report the requirement to the network side, and request the transmission resource from the network side, to obtain resource allocation of the network side.

Optionally, when there is an active communication requirement of the Ambient IoT device near the first communication node (for example, the terminal), for example, a requirement for single active communication, the UE may report the requirement to the network side, and request the transmission resource from the network side, to obtain resource allocation of the network side.

Optionally, the first communication node (for example, the terminal) reports the requirement to the network side, and a reporting process of requesting the transmission resource from the network side may be multiplexed with a reporting procedure in a related technology, for example, UL assistance information.

Optionally, the first communication node (for example, the terminal) reports the requirement to the network side, and a reporting process of requesting the transmission resource from the network side may be performed by using a dedicated reporting process.

Optionally, after the network side obtains reporting of a periodic active communication request requirement of the Ambient IoT device, the network side may send a periodic resource grant based on the requirement of the first communication node (for example, the terminal).

Optionally, that the first communication node requests the transmission resource from a network side includes:

The first communication node sends transmission resource request information to the network side, where the transmission resource request information includes at least one of the following:
a requirement for active communication of the Ambient IoT device;
a resource size required for the active communication of the Ambient IoT device;
a communication type for the active communication of the Ambient IoT device;
transmit power information of the first communication node;
coverage information of the first communication node;
location information of the first communication node;
a quantity of Ambient IoT devices near the first communication node;
density of Ambient IoT devices near the first communication node;
a fourth indication information, where the fourth indication information is used to indicate the first communication node to request a periodic transmission resource; and
period information of the periodic transmission resource requested by the first communication node.

Optionally, when the first communication node (for example, the terminal) reports the requirement to the network side, and requests the transmission resource from the network side, the first communication node may send the transmission resource request information to the network side. The information that needs to be carried includes at least one of the following: a requirement for communication between the UE and the Ambient IoT device, a resource size required for communication between the first communication node (for example, the terminal) and the Ambient IoT device, periodic information, a communication type, transmit power information of the UE, coverage information, location information, a quantity and/or density of Ambient IoT devices near the UE, a resource or resource reservation window that needs to be reserved for uplink transmission, link quality of the first communication node, surrounding interference, and the like.

In an embodiment, when the first communication node (for example, the terminal) has a requirement of periodically communicating with the Ambient IoT device, for example, periodic inventory or measurement result collection, the first communication node (for example, the terminal) may report the periodic requirement to the network side (for example, the UE sends the transmission resource request information to the network side), and reporting may be multiplexed with an existing process, for example, UL assistance information, or may be performed by using a dedicated reporting process. The information that needs to be carried includes at least one of the following: a requirement for communication between the first communication node (for example, the terminal) and the Ambient IoT device, a resource size required for the communication between the first communication node (for example, the terminal) and the Ambient IoT device, periodic information, a communication type, transmit power information of the first communication node (for example, the terminal), coverage information, location information, a quantity and/or density of Ambient IoT devices near the first communication node (for example, the terminal), a resource or resource reservation window that needs to be reserved for uplink transmission, link quality of the first communication node, surrounding interference, and the like.

After receiving the transmission resource request information, the base station may send a periodic resource grant to the first communication node (for example, the terminal) based on the requirement of the first communication node (for example, the terminal), where the periodic resource grant mainly clearly indicates periodic information of the resource, and also includes not only a resource for sending a signal to the Ambient IoT device by the UE, but also a window resource for responding by the Ambient IoT device. The network side may send the two parts of resources to the first communication node (for example, the terminal), or send only the first part of resources used by the first communication node (for example, the terminal) to the first communication node (for example, the terminal). The second part is reserved by a system or is synchronization-associated with the first part by default, and is not allocated to other nearby transmission for use, to ensure effect of periodic IoT communication, and reduce mutual interference.

In an embodiment, when there is a periodic active communication requirement of the Ambient IoT device near the first communication node (for example, the terminal), for example, reporting of a periodic measurement result, the UE may report the periodic requirement to the network side (for example, the UE sends the transmission resource request information to the network side), and reporting may be multiplexed with an existing process, for example, UL assistance information, or may be performed by using a dedicated reporting process. The information that needs to be carried includes at least one of the following: a requirement for communication between the UE and the Ambient IoT device, a resource size required for the communication between the UE and the Ambient IoT device, periodic information, a communication type, transmit power information of the UE, coverage information, location information, a quantity and/or density of Ambient IoT devices near the UE, a resource or resource reservation window that needs to be reserved for uplink transmission, link quality of the first communication node, surrounding interference, and the like.

After receiving reporting of the periodic active communication requirement of the Ambient IoT device, the base station may send a periodic resource grant to the first communication node (for example, the terminal) based on the requirement of the first communication node (for example, the terminal), where the periodic resource grant mainly clearly indicates periodic information of the resource, and mainly includes a location of the resource used by the IoT device; and after receiving the periodic resource grant from the network side, the first communication node (for example, the terminal) may deliver the information to the nearby Ambient IoT device by using the communication process of the Ambient IoT device, so that the Ambient IoT device subsequently uses as required.

In an embodiment, when there is an active communication requirement of the Ambient IoT device near the first communication node (for example, the terminal), where the requirement may alternatively be a single-trigger-based requirement, the Ambient IoT device notifies the first communication node (for example, the terminal) of the requirement by using some preconfigured locations (the second indication resource location), the first communication node (for example, the terminal) reports the requirement to the base station, and the base station allocates a resource based on the requirement, where the allocated resource may be directly sent by the base station to the Ambient IoT device, or may be forwarded by the first communication node (for example, the terminal); and then the Ambient IoT device uses based on the allocated resource.

Optionally, when there is an active communication requirement of the Ambient IoT device near the first communication node (for example, the terminal), the network side allocates a resource to the Ambient IoT device, where the allocated resource may be directly sent by the network side to the Ambient IoT device, or may be forwarded by the first communication node (for example, the terminal); and then the Ambient IoT device uses based on the allocated resource.

Optionally, the related information of the transmission resource includes at least one of the following:
related information of a resource used by the Ambient IoT device to send a signal; and
period information of the resource used by the Ambient IoT device to send the signal.

Optionally, the resource grant indicates the related information of the transmission resource, and the related information may include the related information of the resource used by the Ambient IoT device to send the signal, and/or the period information of the resource used by the Ambient IoT device to send the signal.

Optionally, when there is a periodic active communication requirement of the Ambient IoT device near the first communication node (for example, the terminal), or when there is a requirement for single active communication of the Ambient IoT devices, the first communication node (for example, the terminal) may alternatively report the requirement to the network side, and request the transmission resource from the network side, to obtain resource allocation of the network side, where the related information of the transmission resource sent by the network side includes at least one of the following: the related information of the resource used by the Ambient IoT device to send the signal, and the period information of the resource used by the Ambient IoT device to send the signal.

In an embodiment, after receiving the periodic active communication reporting requirement of the IoT device, the network side, for example, the base station, may send a periodic resource grant to the first communication node (for example, the terminal) based on the requirement of the first communication node (for example, the terminal), where the periodic resource grant mainly clearly indicates periodic information of the resource, and mainly includes a location of the resource used by the Ambient IoT device.

Optionally, the first communication node includes a terminal, and
that a first communication node determines a transmission resource includes:

The first communication node performs resource selection based on a first resource pool configured by a network side, to determine the transmission resource.

Optionally, because the network node is generally far away from the IoT device and requires high transmit power and a large coverage area, a nearby UE may directly communicate with the Ambient IoT device as the first communication node, and then forward response information of the Ambient IoT device to the network side, which is also a reasonable and feasible manner of the Ambient IoT device.

Optionally, in a case of a large quantity of terminals, there is not only a UE in a CONNECTED state, but also a large quantity of UEs in an IDLE/INACTIVE state. These UEs cannot directly communicate with the base station to obtain resources, but need to use another manner, for example, a manner of autonomously selecting a resource in the configured first resource pool for communication of the IoT device.

Optionally, because a resource used for UE communication in the network is generally also scheduled and managed by the base station, when the UE is in a non-RRC CONNECTED state, for example, an IDLE/INACTVIE state, the resource used by the UE to communicate with the Ambient IoT device as the first communication node may be determined after resource selection is performed based on the first resource pool configured by the network side.

Optionally, if the network node, for example, a gNB, supports a function of communication between the UE and the IoT device, the gNB may configure a dedicated resource pool (the first resource pool) for the communication between the UE and the IoT device.

Optionally, the first resource pool may be a common configuration, for example, configured in a SIB or other common signaling. In this case, all first communication nodes (for example, terminals) that have a requirement and are granted to communicate with the Ambient IoT device may use the resource in the resource pool. If the gNB supports the function, but this is not provided in the SIB or common signaling, the first communication node (for example, the terminal) may also request the gNB to configure the resource pool for the first communication node (for example, the terminal) by the gNB.

In an embodiment, the UE is in a non-RRC CONNECTED state, for example, an IDLE/INACTVIE state, and a resource for communication between the UE and another IoT device may be obtained in the following manner:

If the network node, for example, the gNB, supports a function of communication between the UE and the IoT device, the gNB may configure a dedicated first resource pool for the communication between the UE and the IoT device. The first resource pool may be a common configuration, for example, configured in a SIB or other common signaling. In this case, all UEs that have a requirement and are granted to communicate with the IoT device may use the resource in the resource pool. If the gNB supports the function, but this is not provided in the SIB or common signaling, the UE may also request the gNB to configure the resource pool for the UE by the gNB.

In addition, the first resource pool for the communication between the UE and the IoT device may be a resource pool dedicated to the communication, or may be multiplexed with a resource pool for other UE-to-UE communication, for example, PC5 communication.

When the UE has a requirement of sending the signal to the IoT device, resource selection is performed according to a sensing rule in the foregoing configured first resource pool, and reservation is announced to another UE for the selected resource. In addition to meeting that the UE sends the signal to the IoT device, the selected resource may further include a window resource for responding by the IoT device, or the second part is reserved by a system or is synchronization-associated with the first part by default, and is not used in other nearby transmission, to ensure effect of this time of IoT communication, and reduce mutual interference.

When the UE has a requirement of periodically communicating with the IoT device, for example, periodic inventory or measurement result collection, the UE may also reserve a periodic resource in the resource pool. For the periodic resource, a requirement for communication between the UE and the Ambient IoT device, a resource size required for the communication between the UE and the Ambient IoT device, periodic information, a communication type, transmit power information of the UE, coverage information, location information, a quantity and/or density of Ambient IoT devices near the UE, a resource or resource reservation window that needs to be reserved for uplink transmission, link quality of the first communication node, surrounding interference, and the like are considered.

In an embodiment, the UE is in a non-RRC CONNECTED state, for example, an IDLE/INACTVIE state. Because of the UE in the network, if another IoT device near the UE has a communication requirement of actively sending the signal, may be obtained in the following manner:

First, the UE also needs to be configured with the resource pool. If the network node, for example, the gNB, supports a function of communication between the UE and the IoT device, the gNB may configure a dedicated resource pool for the communication between the UE and the IoT device. The first resource pool may be a common configuration, for example, configured in a SIB or other common signaling. In this case, all UEs that have a requirement and are granted to communicate with the IoT device may use the resource in the resource pool. If the gNB supports the function, but this is not provided in the SIB or common signaling, the UE may also request the gNB to configure the resource pool for the UE by the gNB.

In addition, the resource pool for the communication between the UE and the IoT device may be a resource pool dedicated to the communication, or may be multiplexed with a resource pool for other UE-to-UE communication, for example, PC5 communication.

When there is a requirement for periodic active communication of the IoT device near the UE, for example, reporting of a periodic measurement result, the UE may also reserve a periodic resource in the resource pool based on the periodic requirement. For the periodic resource, a requirement for communication between the UE and the Ambient IoT device, a resource size required for the communication between the UE and the Ambient IoT device, periodic information, a communication type, transmit power information of the UE, coverage information, location information, a quantity and/or density of Ambient IoT devices near the UE, a resource or resource reservation window that needs to be reserved for uplink transmission, link quality of the first communication node, surrounding interference, and the like are considered.

After reserving the periodic resource grant in the resource pool, the UE may deliver the information to the nearby IoT device by using the communication process of the IoT device, so that the IoT device subsequently uses as required.

When there is an active communication requirement of the IoT device near the UE, where the requirement may alternatively be a single-trigger-based requirement, the IoT device notifies the UE of the requirement by using some preconfigured locations, the UE selects and reserves a resource in the resource pool based on the requirement, and then the UE directly sends the resource to the IoT device, so that the IoT device uses based on the allocated resource.

Optionally, the transmission resource includes at least one of the following:
related information of a resource used by the first communication node to send a signal to the Ambient IoT device;
related information of a response window used by the Ambient IoT device to respond to the first communication node;
period information of the resource used by the first communication node to send the signal to the Ambient IoT device; and
the period information of the response window.

Optionally, that the first communication node performs resource selection based on a first resource pool configured by a network side, to determine the transmission resource includes at least one of the following:
related information of a resource used by the first communication node to send a signal to the Ambient IoT device; and
related information of a response window used by the Ambient IoT device to respond to the first communication node.

Optionally, when the communication demand between the first communication node and the Ambient IoT device is periodic communication, the first communication node performs resource selection based on the first resource pool configured on the network side, and the determined transmission resource may also include at least one of the following:
period information of the resource used by the first communication node to send the signal to the Ambient IoT device; and
the period information of the response window.

In an embodiment, the first communication node performs resource selection based on the first resource pool configured by the network side. In addition to meeting that the first communication node (for example, the terminal) sends the signal to the Ambient IoT device, the selected resource may further include a window resource for responding by the Ambient IoT device, or the second part is reserved by a system or is synchronization-associated with the first part by default, and is not used in other nearby transmission, to ensure effect of this time of IoT communication, and reduce mutual interference.

Optionally, that the first communication node performs resource selection based on a first resource pool configured by a network side, to determine the transmission resource includes:

The first communication node performs resource selection based on the first resource pool configured by the network side and a resource selection reference information, to determine the transmission resource, where
the resource selection reference information includes at least one of the following:
a requirement for communication between the first communication node and the Ambient IoT device;
a resource size required for the communication between the first communication node and the Ambient IoT device;
a type for the communication between the first communication node and the Ambient IoT device;
transmit power information of the first communication node;
coverage information of the first communication node;
location information of the first communication node;
a quantity of Ambient IoT devices near the first communication node;
density of Ambient IoT devices near the first communication node;
the related information of the response window, where the response window is used to transmit a response signal of the Ambient IoT device to the first communication node; and
period information of a periodic transmission resource selected by the first communication node.

Optionally, when the first communication node (for example, the terminal) has a requirement of sending the signal to the Ambient IoT device, resource selection is performed according to a sensing rule in the first resource pool, and reservation is announced to another UE for the selected resource. In addition to meeting that the first communication node (for example, the terminal) sends the signal to the Ambient IoT device, the selected resource may further include a window resource for responding by the Ambient IoT device, or the second part is reserved by a system or is synchronization-associated with the first part by default, and is not used in other nearby transmission, to ensure effect of this time of IoT communication, and reduce mutual interference.

Optionally, when the first communication node (for example, the terminal) has a requirement of periodically communicating with the Ambient IoT device, for example, periodic inventory or measurement result collection, the first communication node (for example, the terminal) may also reserve the periodic resource in the first resource pool, to perform resource selection.

Optionally, resource selection may be performed based on the resource selection reference information, that is, resource selection may be performed based on at least one of the following: a requirement for communication between the first communication node and the Ambient IoT device, a resource size required for the communication between the first communication node and the Ambient IoT device, periodic information, a type for the communication between the first communication node and the Ambient IoT device, transmit power information of the first communication node, coverage information of the first communication node, location information of the first communication node, a quantity and/or density of Ambient IoT devices near the first communication node, a resource or resource reservation window that needs to be reserved for uplink transmission, link quality of the first communication node, surrounding interference, and the like.

Optionally, before that the first communication node determines the first resource pool configured by the network side, the method further includes at least one of the following:
the first communication node determines that the Ambient IoT device needs to send a signal to the first communication node;
the first communication node receives, at a reserved third indication resource location, fourth information of the Ambient IoT device, where the fourth information is used to represent that the Ambient IoT device needs to send an uplink signal; and
the first communication node determines that the Ambient IoT device needs to periodically send the signal to the first communication node.

Optionally, if the UE in the network is used as the first communication node, and another Ambient IoT device near the UE has a communication requirement of actively sending the signal, the terminal may perform resource selection based on the first resource pool, to determine the transmission resource when determining that the Ambient IoT device needs active communication.

In addition, the resource pool for the communication between the first communication node (for example, the terminal) and the Ambient IoT device may be a resource pool dedicated to the communication, or may be multiplexed with a resource pool for other UE-to-UE communication, for example, PC5 communication.

When there is a requirement for periodic active communication of the IoT device near the first communication node (for example, the terminal), for example, reporting of a periodic measurement result, the first communication node (for example, the terminal) may also reserve a periodic resource in the resource pool based on the periodic requirement. When the periodic transmission resource is determined or the periodic resource is reserved, a requirement for communication between the first communication node and the Ambient IoT device, a resource size required for the communication between the first communication node and the Ambient IoT device, periodic information, a type for the communication between the first communication node and the Ambient IoT device, transmit power information of the first communication node, coverage information of the first communication node, location information of the first communication node, a quantity and/or density of Ambient IoT devices near the first communication node, a resource or resource reservation window that needs to be reserved for uplink transmission, link quality of the first communication node, surrounding interference, and the like need to be considered.

Optionally, after reserving the periodic resource grant in the resource pool, the first communication node (for example, the terminal) may deliver the information to the nearby Ambient IoT device by using the communication process of the Ambient IoT device, so that the Ambient IoT device subsequently uses as required.

In an embodiment, when there is an active communication requirement of the Ambient IoT device near the first communication node (for example, the terminal), where the requirement may alternatively be a single-trigger-based requirement, the Ambient IoT device notifies the first communication node (for example, the terminal) of the requirement by using some preconfigured locations (for example, a third indication resource location), the first communication node (for example, the terminal) selects and reserves a resource in the first resource pool based on the requirement, and then the first communication node (for example, the terminal) directly sends the transmission resource to the Ambient IoT device, so that the Ambient IoT device uses based on the allocated resource.

Optionally, before that the first communication node determines the first resource pool configured by the network side, the method further includes:

The first communication node requests the first resource pool from the network side.

Optionally, the first communication node (for example, the terminal) may request the first resource pool from the network side in advance, so that when the terminal subsequently has a requirement of communicating with the Ambient IoT device or the Ambient IoT device has an active communication requirement, resource selection may be performed, to determine the transmission resource.

Optionally, the first resource pool is an IoT dedicated resource pool, or the first resource pool is multiplexed with a UE-to-UE resource pool.

Optionally, the first resource pool for the communication between the first communication node (for example, the terminal) and the Ambient IoT device may be a resource pool dedicated to the communication between the first communication node (for example, the terminal) and the Ambient IoT device, or may be multiplexed with a resource pool for other UE-to-UE communication, for example, PC5 communication.

The resource determining method provided in embodiments of this application may be performed by a resource determining apparatus. In embodiments of this application, that the resource determining apparatus performs the resource determining method is used as an example to describe the resource determining apparatus provided in embodiments of this application.

FIG. 6 is a schematic diagram of a structure of a resource determining apparatus according to an embodiment of this application. As shown in FIG. 6, the apparatus 600 includes:
a first determining module 610, configured to determine a transmission resource, where the transmission resource is used to transmit information about an ambient power-enabled internet of things Ambient IoT device.

In this embodiment of this application, the transmission resource used to transmit the information about the Ambient IoT device is determined, to implement a transmission requirement of the Ambient IoT device, so that impact and interference caused on other communication in a wireless communication network can be avoided, and excessive complexity is not introduced to the network, thereby implementing coexistence between the Ambient IoT device and the other communication, and improving communication quality.

Optionally, the transmission resource includes a downlink transmission resource, and the first communication node includes a network node; and
the first determining module is configured to perform at least one of the following:
determining that the downlink transmission resource includes a downlink slot in which downlink transmission of a terminal is located;
determining that the downlink transmission resource and the downlink transmission of the terminal are in different downlink slots; and
determining that the downlink transmission resource includes a first downlink slot, where the first downlink slot is not used for the downlink transmission of the terminal.

Optionally, the first determining module is configured to:
determine that the information about the Ambient IoT device is carried on a physical downlink channel, where the physical downlink channel carries an IoT dedicated parameter, or a parameter field of the physical downlink channel includes an IoT dedicated parameter field, or the physical downlink channel is not used for the downlink transmission of the terminal.

Optionally, the transmission resource further includes a resource reservation window, and the resource reservation window is used for an uplink response of the Ambient IoT device; and
the first determining module is configured to perform at least one of the following:
determining a start location of the resource reservation window based on a location of the downlink transmission resource and a minimum interval between the downlink transmission resource and the uplink response; and
determining a length of the resource reservation window based on transmission-related information, where the transmission-related information includes at least one of the following: strength of a signal sent by a base station, a coverage area of the base station, information about a transmission link of the information about the Ambient IoT device, occlusion information of the transmission link, a quantity of Ambient IoT devices in the coverage area of the base station, and density of Ambient IoT devices in the coverage area of the base station.

Optionally, the resource reservation window is located in a location of an uplink transmission resource of the terminal, and/or the resource reservation window is located in a location of a random access resource of the terminal.

Optionally, the apparatus further includes:
a first sending module, configured to send first indication information to the Ambient IoT device, where the first indication information is used to indicate at least one of the following: the start location of the resource reservation window and the length of the resource reservation window.

Optionally, the transmission resource includes a reserved uplink transmission resource, and the uplink transmission resource is used for active reporting of the Ambient IoT device; and
in a case that the first communication node includes the network node, the first determining module is configured to:
determine a first information separately corresponding to at least one group of period resource groups, where the first information includes at least one of the following: a period interval, a resource size, an applicable transmission requirement, an applicable transmission service, and a use rule.

Optionally, the transmission resource includes an uplink transmission resource, and
the apparatus further includes:
a first receiving module, configured to: before the first communication node determines the transmission resource, receive, at a reserved first indication resource location, second information of the Ambient IoT device, where the second information is used to represent that the Ambient IoT device needs to send an uplink signal; and
the first determining module is configured to:
determine the uplink transmission resource.

Optionally, the second information includes at least one of the following:
a second indication information, where the second indication information is used to indicate that the Ambient IoT device needs to send the uplink signal;
a resource size required for the uplink signal that needs to be sent by the Ambient IoT device; and
a service type corresponding to the uplink signal.

Optionally, the first communication node includes a terminal, and
the first determining module is configured to perform at least one of the following:
requesting the transmission resource from a network side; and
receiving a resource grant sent by the network side, where the resource grant is used to indicate related information of the transmission resource.

Optionally, the apparatus further includes at least one of the following:
a second receiving module, configured to: before the first communication node requests the transmission resource from the network side, receive control information sent by a third communication node, where the control information is used to indicate the first communication node to communicate with the Ambient IoT device; and
a second determining module, configured to: before the first communication node requests the transmission resource from the network side, determine that a first trigger condition is met, where the first trigger condition is used to trigger the first communication node to communicate with the Ambient IoT device.

Optionally, the first determining module is configured to:
send transmission resource request information to the network side, where the transmission resource request information includes at least one of the following:
a requirement for the communication between the first communication node and the Ambient IoT device;
a resource size required for the communication between the first communication node and the Ambient IoT device;
a type for the communication between the first communication node and the Ambient IoT device;
transmit power information of the first communication node;
coverage information of the first communication node;
location information of the first communication node;
a quantity of Ambient IoT devices near the first communication node;
density of Ambient IoT devices near the first communication node;
related information of a response window, where the response window is used to transmit a response of the Ambient IoT device to the first communication node;
third indication information, where the third indication information is used to indicate the first communication node to request a periodic transmission resource; and
period information of the periodic transmission resource requested by the first communication node.

Optionally, the related information of the transmission resource includes at least one of the following:
related information of a resource used by the first communication node to send a signal to the Ambient IoT device;
the related information of the response window used by the Ambient IoT device to respond to the first communication node;
period information of the resource used by the first communication node to send the signal to the Ambient IoT device; and
period information of the response window.

Optionally, the apparatus further includes at least one of the following:
a third determining module, configured to: before the first communication node requests the transmission resource from the network side, determine that the Ambient IoT device needs to send a signal to the first communication node;
a third receiving module, configured to: before the first communication node requests the transmission resource from the network side, receive, at a reserved second indication resource location, third information of the Ambient IoT device, where the third information is used to represent that the Ambient IoT device needs to send an uplink signal; and
a fourth determining module, configured to: before the first communication node requests the transmission resource from the network side, determine that the Ambient IoT device needs to periodically send the signal to the first communication node.

Optionally, the first determining module is configured to:
send transmission resource request information to the network side, where the transmission resource request information includes at least one of the following:
a requirement for active communication of the Ambient IoT device;
a resource size required for the active communication of the Ambient IoT device;
a communication type for the active communication of the Ambient IoT device;
transmit power information of the first communication node;
coverage information of the first communication node;
location information of the first communication node;
a quantity of Ambient IoT devices near the first communication node;
density of Ambient IoT devices near the first communication node;
a fourth indication information, where the fourth indication information is used to indicate the first communication node to request a periodic transmission resource; and
period information of the periodic transmission resource requested by the first communication node.

Optionally, the related information of the transmission resource includes at least one of the following:
related information of a resource used by the Ambient IoT device to send a signal; and
period information of the resource used by the Ambient IoT device to send the signal.

Optionally, the first communication node includes a terminal, and
the first determining module is configured to:
perform resource selection based on a first resource pool configured by a network side, to determine the transmission resource.

Optionally, the transmission resource includes at least one of the following:
related information of a resource used by the first communication node to send a signal to the Ambient IoT device;
related information of a response window used by the Ambient IoT device to respond to the first communication node;
period information of the resource used by the first communication node to send the signal to the Ambient IoT device; and
period information of the response window.

Optionally, the first determining module is configured to:
perform resource selection based on the first resource pool configured by the network side and resource selection reference information, to determine the transmission resource, where
the resource selection reference information includes at least one of the following:
a requirement for communication between the first communication node and the Ambient IoT device;
a resource size required for the communication between the first communication node and the Ambient IoT device;
a type for the communication between the first communication node and the Ambient IoT device;
transmit power information of the first communication node;
coverage information of the first communication node;
location information of the first communication node;
a quantity of Ambient IoT devices near the first communication node;
density of Ambient IoT devices near the first communication node;
the related information of the response window, where the response window is used to transmit a response signal of the Ambient IoT device to the first communication node; and
period information of a periodic transmission resource selected by the first communication node.

Optionally, the apparatus further includes at least one of the following:
a fifth determining module, configured to: before the first communication node determines the first resource pool configured by the network side, determine that the Ambient IoT device needs to send a signal to the first communication node;
a fourth receiving module, configured to: before the first communication node determines the first resource pool configured by the network side, receive, at a reserved third indication resource location, fourth information of the Ambient IoT device, where the fourth information is used to represent that the Ambient IoT device needs to send an uplink signal; and
a sixth determining module, configured to: before the first communication node determines the first resource pool configured by the network side, determine that the Ambient IoT device needs to periodically send the signal to the first communication node.

Optionally, the apparatus further includes:
a second request module, configured to: before the first communication node determines the first resource pool configured by the network side, request the first resource pool from the network side.

Optionally, the first resource pool is an IoT dedicated resource pool, or the first resource pool is multiplexed with a UE-to-UE resource pool.

In this embodiment of this application, when the first communication node is the network node, that is, when the network node communicates with the Ambient IoT device, for resource allocation, parameters such as a scattering or feedback window length and a pattern of a plurality of Ambient IoT devices may be considered, so that the Ambient IoT devices are located in a dedicated slot or a legacy UE RACH resource slot, thereby reducing interference to a legacy UE UL. If there is an active transmission requirement of an active Ambient IoT, dedicated uplink resources can be allocated, and multiplexing with a legacy UE RACH is considered.

In this embodiment of this application, the first communication node is the terminal, that is, when a UE communicates with the Ambient IoT device, if the UE has a communication requirement, the UE performs a resource request to the network side to report a special requirement of IoT communication. The network allocates a resource to the UE based on power and coverage of the UE and a quantity and density of IoT devices existing near the UE. The resource includes a resource for transmitting an IoT command by the UE and a resource for performing scattering or feedback by the IoT device.

Optionally, the UE may further report a network resource.

When the UE has a resource pool configuration, the UE may autonomously perform resource selection, perform sensing (sensing) monitoring in the first resource pool, and reserve a resource that meets an IoT communication requirement. The resource includes a resource for transmitting an IoT command by the UE and a resource for performing scattering or feedback by the IoT device. For the feedback resource, a coverage capability of the UE and a quantity and density of IoT devices existing near the UE need to be considered.

If there is an active transmission requirement of the active Ambient IoT to the UE, the UE may report the requirement to the network side. The network allocates a periodic resource to the UE based on the power and the coverage of the UE and the quantity and the density of IoT devices existing near the UE, and the UE sends the periodic resource to the active Ambient IoT device for active transmission of the active Ambient IoT device. Certainly, in this step, it is not excluded that the sending resource is directly sent by the network to the IoT device.

If there is an active transmission requirement of the active Ambient IoT to the UE, the UE has a first resource pool configuration, and may reserve a periodic resource in the first resource pool according to a sensing principle. For the periodic resource, the power and the coverage of the UE and the quantity and the density of IoT devices existing near the UE need to be considered, and the UE sends the periodic resource to the active Ambient IoT device for active transmission of the active Ambient IoT device.

The resource determining apparatus in this embodiment of this application may be an electronic device, for example, an electronic device with an operating system, or may be a component in the electronic device, for example, an integrated circuit or a chip. The electronic device may be a terminal, or may be another device that is not the terminal. For example, the terminal may include but is not limited to the foregoing listed types of the terminal 11, and the another device may be a server, a network attached storage (NAS), or the like. This is not specifically limited in this embodiment of this application.

The resource determining apparatus provided in this embodiment of this application can implement the processes implemented in the method embodiment in FIG. 4 and FIG. 5, and same technical effect is achieved. To avoid repetition, details are not described herein again.

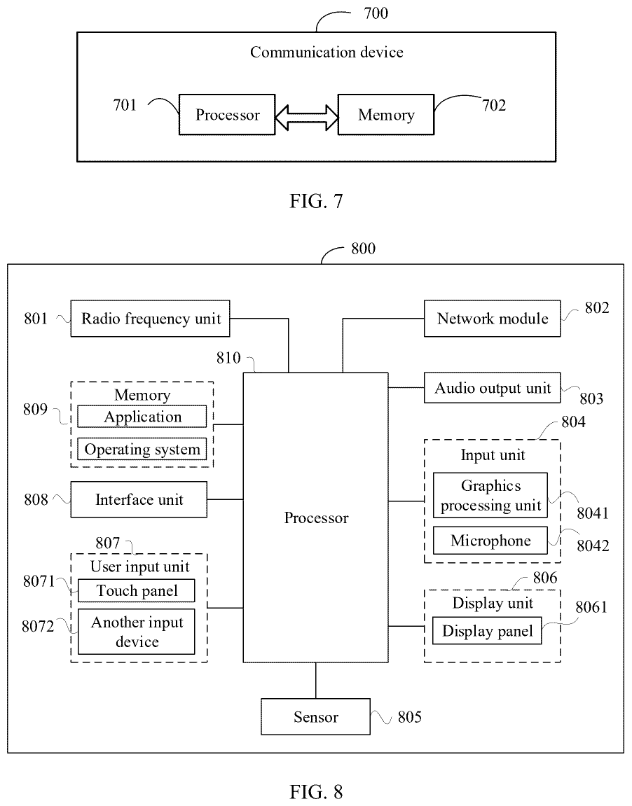

Optionally, FIG. 7 is a schematic diagram of a structure of a communication device according to an embodiment of this application. As shown in FIG. 7, an embodiment of this application further provides a communication device 700. The communication device 700 includes a processor 701 and a memory 702, and the memory 702 stores a program or an instruction that is executable on the processor 701. For example, when the communication device 700 is a terminal, the program or the instruction is executed by the processor 701, the steps of the embodiment of the foregoing resource determining method are implemented, and same technical effect can be achieved. When the communication device 700 is a network side device, and the program or the instruction is executed by the processor 701, the steps of the embodiment of the foregoing resource determining method are implemented, and same technical effect can be achieved. To avoid repetition, details are not described herein again. Optionally, a first communication node may be a terminal.

An embodiment of this application further provides a terminal. The terminal includes a processor and a communication interface. The processor is configured to determine a transmission resource, where the transmission resource is used to transmit information about an ambient power-enabled internet of things Ambient IoT device.

The terminal embodiment corresponds to the method embodiment on the terminal side, each implementation process and implementation of the method embodiment can be applied to the terminal embodiment, and same technical effect can be achieved. Specifically, FIG. 8 is a schematic diagram of a hardware structure of a terminal according to an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the terminal 800 may further include a power supply (for example, a battery) that supplies power to each component. The power supply may be logically connected to the processor 810 by using a power supply management system, to implement functions such as charging and discharging management, and power consumption management by using the power supply management system. The structure of the terminal shown in FIG. 8 constitutes no limitation on the terminal. The terminal may include more or fewer components than those shown in the figure, or combine some components, or have different component arrangements. Details are not described herein.

It should be understood that in this embodiment of this application, the input unit 804 may include a graphics processing unit (GPU) 8041 and a microphone 8042, and the graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (for example, a volume control button or a power on/off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Usually, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, and an application or an instruction required by at least one function (for example, a sound playing function or an image playing function). In addition, the memory 809 may be a volatile memory or a non-volatile memory, or the memory 809 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 809 in this embodiment of this application includes but is not limited to these memories and any memory of another proper type.

The processor 810 may include one or more processing units. Optionally, an application processor and a modem processor are integrated into the processor 810. The application processor mainly processes an operating system, a user interface, an application, or the like. The modem processor mainly processes a wireless communication signal, for example, a baseband processor. It may be understood that, alternatively, the modem processor may not be integrated into the processor 810.

The processor 810 is configured to determine a transmission resource, where the transmission resource is used to transmit information about an ambient power-enabled internet of things Ambient IoT device.

In this embodiment of this application, the transmission resource used to transmit the information about the Ambient IoT device is determined, to implement a transmission requirement of the Ambient IoT device, so that impact and interference caused on other communication in a wireless communication network can be avoided, and excessive complexity is not introduced to the network, thereby implementing coexistence between the Ambient IoT device and the other communication, and improving communication quality.

Optionally, the transmission resource includes a downlink transmission resource, and the first communication node includes a network node; and
the processor 810 is configured to perform at least one of the following:
determining that the downlink transmission resource includes a downlink slot in which downlink transmission of a terminal is located;
determining that the downlink transmission resource and the downlink transmission of the terminal are in different downlink slots; and
determining that the downlink transmission resource includes a first downlink slot, where the first downlink slot is not used for the downlink transmission of the terminal.

Optionally, the processor 810 is configured to:
determine that the information about the Ambient IoT device is carried on a physical downlink channel, where the physical downlink channel carries an IoT dedicated parameter, or a parameter field of the physical downlink channel includes an IoT dedicated parameter field, or the physical downlink channel is not used for the downlink transmission of the terminal.

Optionally, the transmission resource further includes a resource reservation window, and the resource reservation window is used for an uplink response of the Ambient IoT device; and
the processor 810 is configured to perform at least one of the following:
determining a start location of the resource reservation window based on a location of the downlink transmission resource and a minimum interval between the downlink transmission resource and the uplink response; and
determining a length of the resource reservation window based on transmission-related information, where the transmission-related information includes at least one of the following: strength of a signal sent by a base station, a coverage area of the base station, information about a transmission link of the information about the Ambient IoT device, occlusion information of the transmission link, a quantity of Ambient IoT devices in the coverage area of the base station, and density of Ambient IoT devices in the coverage area of the base station.

Optionally, the resource reservation window is located in a location of an uplink transmission resource of the terminal, and/or the resource reservation window is located in a location of a random access resource of the terminal.

Optionally, the processor 810 is configured to:
send first indication information to the Ambient IoT device, where the first indication information is used to indicate at least one of the following: the start location of the resource reservation window and the length of the resource reservation window.

Optionally, the transmission resource includes a reserved uplink transmission resource, and the uplink transmission resource is used for active reporting of the Ambient IoT device; and
in a case that the first communication node includes the network node, the processor 810 is configured to:
determine first information separately corresponding to at least one group of period resource groups, where the first information includes at least one of the following: a period interval, a resource size, an applicable transmission requirement, an applicable transmission service, and a use rule.

Optionally, the transmission resource includes an uplink transmission resource, and
the processor 810 is configured to:
before the first communication node determines the transmission resource, receive, at a reserved first indication resource location, second information of the Ambient IoT device, where the second information is used to represent that the Ambient IoT device needs to send an uplink signal; and
determine the uplink transmission resource.

Optionally, the second information includes at least one of the following:
a second indication information, where the second indication information is used to indicate that the Ambient IoT device needs to send the uplink signal;
a resource size required for the uplink signal that needs to be sent by the Ambient IoT device; and
a service type corresponding to the uplink signal.

Optionally, the first communication node includes a terminal, and
the processor 810 is configured to perform at least one of the following:
requesting the transmission resource from a network side; and
receiving a resource grant sent by the network side, where the resource grant is used to indicate related information of the transmission resource.

Optionally, the processor 810 is configured to perform at least one of the following:
before the first communication node requests the transmission resource from the network side, receiving control information sent by a third communication node, where the control information is used to indicate the first communication node to communicate with the Ambient IoT device; and
before the first communication node requests the transmission resource from the network side, determining that a first trigger condition is met, where the first trigger condition is used to trigger the first communication node to communicate with the Ambient IoT device.

Optionally, the processor 810 is configured to:
send transmission resource request information to the network side, where the transmission resource request information includes at least one of the following:
a requirement for communication between the first communication node and the Ambient IoT device;
a resource size required for the communication between the first communication node and the Ambient IoT device;
a type for the communication between the first communication node and the Ambient IoT device;
transmit power information of the first communication node;
coverage information of the first communication node;
location information of the first communication node;
a quantity of Ambient IoT devices near the first communication node;
density of Ambient IoT devices near the first communication node;
related information of a response window, where the response window is used to transmit a response of the Ambient IoT device to the first communication node;
a third indication information, where the third indication information is used to indicate the first communication node to request a periodic transmission resource; and
period information of the periodic transmission resource requested by the first communication node.

Optionally, the related information of the transmission resource includes at least one of the following:
related information of a resource used by the first communication node to send a signal to the Ambient IoT device;
the related information of the response window used by the Ambient IoT device to respond to the first communication node;
period information of the resource used by the first communication node to send the signal to the Ambient IoT device; and
period information of the response window.

Optionally, the processor 810 is configured to perform at least one of the following:
before the first communication node requests the transmission resource from the network side, determining that the Ambient IoT device needs to send a signal to the first communication node;
before the first communication node requests the transmission resource from the network side, receiving, at a reserved second indication resource location, third information of the Ambient IoT device, where the third information is used to represent that the Ambient IoT device needs to send an uplink signal; and
before the first communication node requests the transmission resource from the network side, determining that the Ambient IoT device needs to periodically send the signal to the first communication node.

Optionally, the processor 810 is configured to:
send transmission resource request information to the network side, where the transmission resource request information includes at least one of the following:
a requirement for active communication of the Ambient IoT device;
a resource size required for the active communication of the Ambient IoT device;
a communication type for the active communication of the Ambient IoT device;
transmit power information of the first communication node;
coverage information of the first communication node;
location information of the first communication node;
a quantity of Ambient IoT devices near the first communication node;
density of Ambient IoT devices near the first communication node;
a fourth indication information, where the fourth indication information is used to indicate the first communication node to request a periodic transmission resource; and
period information of the periodic transmission resource requested by the first communication node.

Optionally, the related information of the transmission resource includes at least one of the following:
related information of a resource used by the Ambient IoT device to send a signal; and
period information of the resource used by the Ambient IoT device to send the signal.

Optionally, the first communication node includes a terminal, and
the processor 810 is configured to:
perform resource selection based on a first resource pool configured by a network side, to determine the transmission resource.

Optionally, the transmission resource includes at least one of the following:
related information of a resource used by the first communication node to send a signal to the Ambient IoT device;
related information of a response window used by the Ambient IoT device to respond to the first communication node;
period information of the resource used by the first communication node to send the signal to the Ambient IoT device; and
period information of the response window.

Optionally, the processor 810 is configured to:
perform resource selection based on the first resource pool configured by the network side and a resource selection reference information, to determine the transmission resource, where
the resource selection reference information includes at least one of the following:
a requirement for communication between the first communication node and the Ambient IoT device;
a resource size required for the communication between the first communication node and the Ambient IoT device;
a type for the communication between the first communication node and the Ambient IoT device;
transmit power information of the first communication node;
coverage information of the first communication node;
location information of the first communication node;
a quantity of Ambient IoT devices near the first communication node;
density of Ambient IoT devices near the first communication node;
the related information of the response window, where the response window is used to transmit a response signal of the Ambient IoT device to the first communication node; and
period information of a periodic transmission resource selected by the first communication node.

Optionally, the processor 810 is configured to perform at least one of the following:
before the first communication node determines the first resource pool configured by the network side, determining that the Ambient IoT device needs to send a signal to the first communication node;
before the first communication node determines the first resource pool configured by the network side, receiving, at a reserved third indication resource location, a fourth information of the Ambient IoT device, where the fourth information is used to represent that the Ambient IoT device needs to send an uplink signal; and
before the first communication node determines the first resource pool configured by the network side, determining that the Ambient IoT device needs to periodically send the signal to the first communication node.

Optionally, the processor 810 is configured to:
before the first communication node determines the first resource pool configured by the network side, request the first resource pool from the network side.

Optionally, the first resource pool is an IoT dedicated resource pool, or the first resource pool is multiplexed with a UE-to-UE resource pool.

Optionally, the first communication node may be a network node.

An embodiment of this application further provides a network node. The network node includes a processor and a communication interface. The processor is configured to determine a transmission resource, where the transmission resource is used to transmit information about an ambient power-enabled internet of things Ambient IoT device. The network node embodiment corresponds to the method embodiment of the network node, each implementation process and implementation of the method embodiment can be applied to the network node embodiment, and same technical effect can be achieved.

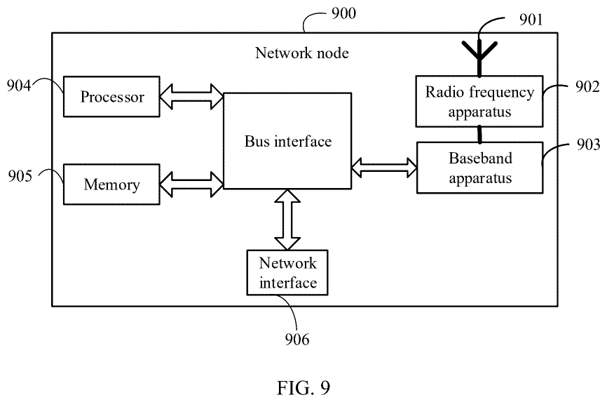

Specifically, an embodiment of this application further provides a network node. FIG. 9 is a schematic diagram of a hardware structure of a network node according to an embodiment of this application. As shown in FIG. 9, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes information that needs to be sent, and sends processed information to the radio frequency apparatus 902. The radio frequency apparatus 902 processes the received information, and sends processed information through the antenna 901.

In the foregoing embodiment, the method performed by the network side device may be implemented in the baseband apparatus 903. The baseband apparatus 903 includes a baseband processor.

For example, the baseband apparatus 903 may include at least one baseband board. A plurality of chips are disposed on the baseband board. As shown in the figure, one chip is, for example, a baseband processor, and is connected to the memory 905 through a bus interface, to invoke a program in the memory 905 to perform the operations of the network device shown in the method embodiment.

The network side device may further include a network interface 906, and the interface is, for example, a common public radio interface (CPRI).

Specifically, the network side device 900 in this embodiment of the present invention further includes an instruction or a program that is stored in the memory 905 and that can be run on the processor 904. The processor 904 invokes the instruction or the program in the memory 905 to perform the method performed by the modules shown in FIG. 6, and same technical effect is achieved. To avoid repetition, details are not described herein again.

An embodiment of this application further provides a readable storage medium. The readable storage medium stores a program or an instruction; and when the program or the instruction is executed by a processor, the processes of the embodiment of the foregoing resource determining method are implemented, and same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor, the processor is configured to run a program or an instruction, to implement the processes of the embodiment of the foregoing resource determining method, and same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, the computer program/program product is executed by at least one processor to implement the processes of the embodiment of the foregoing resource determining method, and same technical effect can be achieved. To avoid repetition, details are not described herein again.

An embodiment of this application further provides a resource determining system. The resource determining system includes: a first communication node, where the first communication node may be configured to perform the steps of the foregoing resource determining method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the method described in embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A resource determining method, comprising:
determining, by a first communication node, a transmission resource, wherein the transmission resource is used to transmit information about an ambient power-enabled internet of things Ambient IoT device.

2. The resource determining method according to claim 1, wherein the transmission resource comprises a downlink transmission resource, and the first communication node comprises a network node; and
the determining, by a first communication node, a transmission resource comprises at least one of the following:
determining, by the first communication node, that the downlink transmission resource comprises a downlink slot in which downlink transmission of a terminal is located;
determining, by the first communication node, that the downlink transmission resource and the downlink transmission of the terminal are in different downlink slots; and
determining, by the first communication node, that the downlink transmission resource comprises a first downlink slot, wherein the first downlink slot is not used for the downlink transmission of the terminal.

3. The resource determining method according to claim 2, wherein the determining, by a first communication node, a transmission resource comprises:
determining, by the first communication node, that the information about the Ambient IoT device is carried on a physical downlink channel, wherein the physical downlink channel carries an IoT dedicated parameter, or a parameter field of the physical downlink channel comprises an IoT dedicated parameter field, or the physical downlink channel is not used for the downlink transmission of the terminal.

4. The resource determining method according to claim 2, wherein the transmission resource further comprises a resource reservation window, and the resource reservation window is used for an uplink response of the Ambient IoT device; and
the determining, by a first communication node, a transmission resource comprises at least one of the following:
determining, by the first communication node, a start location of the resource reservation window based on a location of the downlink transmission resource and a minimum interval between the downlink transmission resource and the uplink response; and
determining, by the first communication node, a length of the resource reservation window based on transmission-related information, wherein the transmission-related information comprises at least one of the following: strength of a signal sent by a base station, a coverage area of the base station, information about a transmission link of the information about the Ambient IoT device, occlusion information of the transmission link, a quantity of Ambient IoT devices in the coverage area of the base station, and density of Ambient IoT devices in the coverage area of the base station.

5. The resource determining method according to claim 4, wherein the resource reservation window is located in at least one of: a location of an uplink transmission resource of the terminal and a location of a random access resource of the terminal.

6. The resource determining method according to claim 4, wherein the method further comprises:
sending, by the first communication node, a first indication information to the Ambient IoT device, wherein the first indication information is used to indicate at least one of the following: the start location of the resource reservation window and the length of the resource reservation window.

7. The resource determining method according to claim 1, wherein the transmission resource comprises a reserved uplink transmission resource, and the uplink transmission resource is used for active reporting of the Ambient IoT device; and
in a case that the first communication node comprises a network node, the determining, by a first communication node, a transmission resource comprises:
determining, by the first communication node, a first information separately corresponding to at least one group of period resource groups, wherein the first information comprises at least one of the following: a period interval, a resource size, an applicable transmission requirement, an applicable transmission service, and a use rule.

8. The resource determining method according to claim 1, wherein the transmission resource comprises an uplink transmission resource, and
before the determining, by a first communication node, a transmission resource, the method further comprises:
receiving, by the first communication node at a reserved first indication resource location, a second information of the Ambient IoT device, wherein the second information is used to represent that the Ambient IoT device needs to send an uplink signal; and
the determining, by a first communication node, a transmission resource comprises:
determining, by the first communication node, the uplink transmission resource.

9. The resource determining method according to claim 8, wherein the second information comprises at least one of the following:
a second indication information, wherein the second indication information is used to indicate that the Ambient IoT device needs to send the uplink signal;
a resource size required for the uplink signal that needs to be sent by the Ambient IoT device; and
a service type corresponding to the uplink signal.

10. The resource determining method according to claim 1, wherein the first communication node comprises a terminal, and
the determining, by a first communication node, a transmission resource comprises at least one of the following:
requesting, by the first communication node, the transmission resource from a network side; and
receiving, by the first communication node, a resource grant sent by the network side, wherein the resource grant is used to indicate related information of the transmission resource.

11. The resource determining method according to claim 10, wherein before the requesting, by the first communication node, the transmission resource from a network side, the method further comprises at least one of the following:
receiving, by the first communication node, control information sent by a third communication node, wherein the control information is used to indicate the first communication node to communicate with the Ambient IoT device; and
determining, by the first communication node, that a first trigger condition is met, wherein the first trigger condition is used to trigger the first communication node to communicate with the Ambient IoT device.

12. The resource determining method according to claim 11, wherein the requesting, by the first communication node, the transmission resource from a network side comprises:
sending, by the first communication node, a transmission resource request information to the network side, wherein the transmission resource request information comprises at least one of the following:
a requirement for the communication between the first communication node and the Ambient IoT device;
a resource size required for the communication between the first communication node and the Ambient IoT device;
a type for the communication between the first communication node and the Ambient IoT device;
a transmit power information of the first communication node;
a coverage information of the first communication node;
a location information of the first communication node;
a quantity of Ambient IoT devices near the first communication node;
a density of Ambient IoT devices near the first communication node;
a related information of a response window, wherein the response window is used to transmit a response of the Ambient IoT device to the first communication node;
a third indication information, wherein the third indication information is used to indicate the first communication node to request a periodic transmission resource; and
a period information of the periodic transmission resource requested by the first communication node.

13. The resource determining method according to claim 11, wherein the related information of the transmission resource comprises at least one of the following:
a related information of a resource used by the first communication node to send a signal to the Ambient IoT device;
the related information of the response window used by the Ambient IoT device to respond to the first communication node;
a period information of the resource used by the first communication node to send the signal to the Ambient IoT device; and
a period information of the response window.

14. The resource determining method according to claim 10, wherein before the requesting, by the first communication node, the transmission resource from a network side, the method further comprises at least one of the following:
determining, by the first communication node, that the Ambient IoT device needs to send a signal to the first communication node;
receiving, by the first communication node at a reserved second indication resource location, a third information of the Ambient IoT device, wherein the third information is used to represent that the Ambient IoT device needs to send an uplink signal; and
determining, by the first communication node, that the Ambient IoT device needs to periodically send the signal to the first communication node.

15. The resource determining method according to claim 14, wherein the requesting, by the first communication node, the transmission resource from a network side comprises:
sending, by the first communication node, a transmission resource request information to the network side, wherein the transmission resource request information comprises at least one of the following:
a requirement for active communication of the Ambient IoT device;
a resource size required for the active communication of the Ambient IoT device;
a communication type for the active communication of the Ambient IoT device;
a transmit power information of the first communication node;
a coverage information of the first communication node;
a location information of the first communication node;
a quantity of Ambient IoT devices near the first communication node;
a density of Ambient IoT devices near the first communication node;
a fourth indication information, wherein the fourth indication information is used to indicate the first communication node to request a periodic transmission resource; and
a period information of the periodic transmission resource requested by the first communication node.

16. The resource determining method according to claim 1, wherein the first communication node comprises a terminal, and
the determining, by a first communication node, a transmission resource comprises:
performing, by the first communication node, resource selection based on a first resource pool configured by a network side, to determine the transmission resource.

17. The resource determining method according to claim 16, wherein the transmission resource comprises at least one of the following:
a related information of a resource used by the first communication node to send a signal to the Ambient IoT device;
a related information of a response window used by the Ambient IoT device to respond to the first communication node;
a period information of the resource used by the first communication node to send the signal to the Ambient IoT device; and
a period information of the response window.

18. The resource determining method according to claim 16, wherein the performing, by the first communication node, resource selection based on a first resource pool configured by the network side, to determine the transmission resource comprises:
performing, by the first communication node, resource selection based on the first resource pool configured by the network side and a resource selection reference information, to determine the transmission resource, wherein
the resource selection reference information comprises at least one of the following:
a requirement for communication between the first communication node and the Ambient IoT device;
a resource size required for the communication between the first communication node and the Ambient IoT device;
a type for the communication between the first communication node and the Ambient IoT device;
a transmit power information of the first communication node;
a coverage information of the first communication node;
a location information of the first communication node;
a quantity of Ambient IoT devices near the first communication node;
a density of Ambient IoT devices near the first communication node;
the related information of the response window, wherein the response window is used to transmit a response signal of the Ambient IoT device to the first communication node; and
a period information of a periodic transmission resource selected by the first communication node.

19. The resource determining method according to claim 16, wherein before the determining, by the first communication node, the first resource pool configured by the network side, the method further comprises at least one of the following:
determining, by the first communication node, that the Ambient IoT device needs to send a signal to the first communication node;
receiving, by the first communication node at a reserved third indication resource location, a fourth information of the Ambient IoT device, wherein the fourth information is used to represent that the Ambient IoT device needs to send an uplink signal; and
determining, by the first communication node, that the Ambient IoT device needs to periodically send the signal to the first communication node.

20. A first communication node, comprising at least one hardware processor and a memory, wherein the memory stores a program or an instruction that is executable on the at least one hardware processor; and when the program or the instruction is executed by the at least one hardware processor, the at least one hardware processor is directed to:
determine a transmission resource, wherein the transmission resource is used to transmit information about an ambient power-enabled internet of things Ambient IoT device.
